(19) United States
(12) Patent Application Publication
(10) Pub. No.: US 2009/0107775 A1
(43) Pub. Date: Apr. 30, 2009

(54) Sod Harvester

(75) Inventors: John Jene Dagorret, Tampa, FL (US); Stephen Richard Mason, Tampa, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(73) Assignee: Automated AG Systems, LLC, Tampa, FL (US)

(21) Appl. No.: 11/923,860

(22) Filed: Oct. 25, 2007

(51) Int. Cl. B66F 9/19

(52) U.S. Cl. 187/237

(57) ABSTRACT

A sod harvesting machine includes a tractor having a first frame, a second frame, a front sod carriage having a first lift member, a rear sod carriage, an elevated platform, vertical support members, and a second lift member. Between the elevated platform and the front and rear sod carriages, the tractor also includes a sod storage compartment into which pallets of stacked sod are mechanically conveyed for storage and transport. The first lift member can be a low vertical lift for lifting the pallet off the ground and conveying the pallet via conveyor chains toward the rear sod carriage. The second frame is telescopically engaged by the first frame so that the length of the sod storage compartment may be extended to accommodate additional pallets. The second lift member can be a high vertical lift for lifting pallets unloaded from the sod storage compartment onto a truck for shipment.

### FIELD OF THE INVENTION

The invention relates to sod harvesting. More particularly, the invention relates to machines and methods for harvesting, transporting, and transferring sod.

### BACKGROUND

In a number of areas, grass lawns are constructed from transplanted sod rather than being grown from seed. Sod is harvested from the ground in squares or rolls using specialized cutting machines. When harvested as squares, several layers of the individual sod squares are stacked on a pallet at a site adjacent to the harvest location. Conventional forklift trucks are then used to transport the palletized stacked sod from the field to the bed of a flatbed truck for transport to an end-user. Unfortunately, because conventional forklift trucks are ill-suited for transporting sod from the field to a truck, use in this manner causes undue wear and tear on the forklift trucks and increases the cost of running a sod harvesting operation.

### SUMMARY

The invention relates to the development of a machine specifically designed to efficiently transport palletized stacked sod from the field to the bed of a flatbed truck for transport to an end-user. In one arrangement, the sod harvesting machine of the invention includes a tractor having a first frame, a second frame, a front sod carriage having a first lift member, a rear sod carriage, an elevated platform, and a second lift member. The elevated platform can be supported by vertical support members connected to the first frame. The first and second frames, front and rear sod carriages, elevated platform, and vertical support members form a sod storage compartment into which pallets of stacked sod are mechanically conveyed for transport to an unloading location. The first lift member may be a low vertical lift for lifting the pallet off the ground and mechanically conveying the pallet via conveyor chains to the rear sod carriage which also includes conveyor chains. The second frame may be telescopically and slidably engaged by the first frame so that the length of the tractor and its sod storage compartment may be extended to accommodate additional pallets of stacked sod. The conveyor chains of the front and rear sod carriages are reversible in direction so that pallets may be loaded and unloaded. The second lift member can be a high vertical lift for lifting pallets unloaded from the sod storage compartment onto a truck for shipment.

Unless otherwise defined, all technical terms used herein have the same meaning as commonly understood by one of ordinary skill in the art to which this invention belongs. Although methods, materials, and equipment similar or equivalent to those described herein can be used in the practice or testing of the present invention, suitable methods, materials, and equipment are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a perspective view of a sod harvesting machine of the invention.

FIG. 2A is a side view of the sod harvesting machine of FIG. 1 shown in a shortened configuration.

FIG. 2B is a side view of the sod harvesting machine of FIG. 1 shown in an extended configuration.

FIG. 3A is a top view of the sod harvesting machine of FIG. 1.

FIG. 3B is a top view of the sod harvesting machine of FIG. 1.

FIG. 4 is a perspective view of the sod harvesting machine of FIG. 1 shown with a first lift member, aligned with a pallet of stacked sod and having a second lift member removed.

FIG. 5 is a perspective view of the sod harvesting machine of FIG. 1 shown holding five pallets of stacked sod within a sod storage compartment of the sod harvesting machine.

FIG. 6 is a perspective view of the sod harvesting machine of FIG. 1 lifting and loading a pallet of stacked sod onto a bed of a flatbed truck.

### DETAILED DESCRIPTION

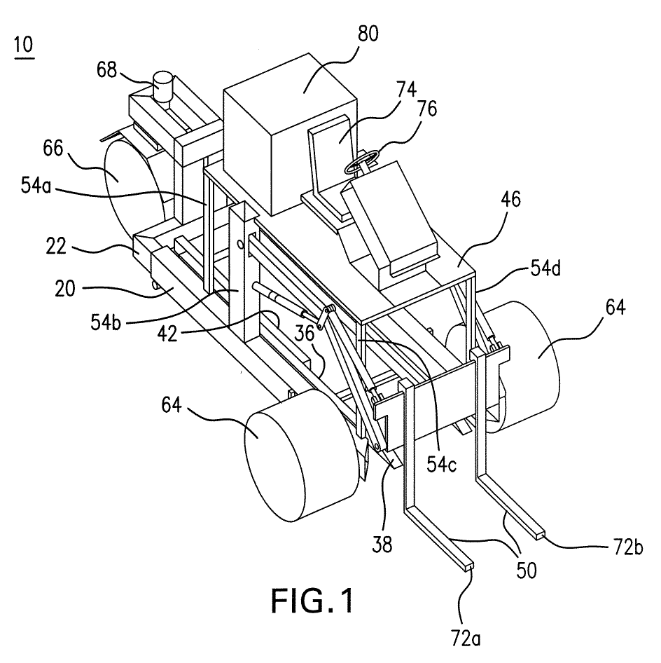

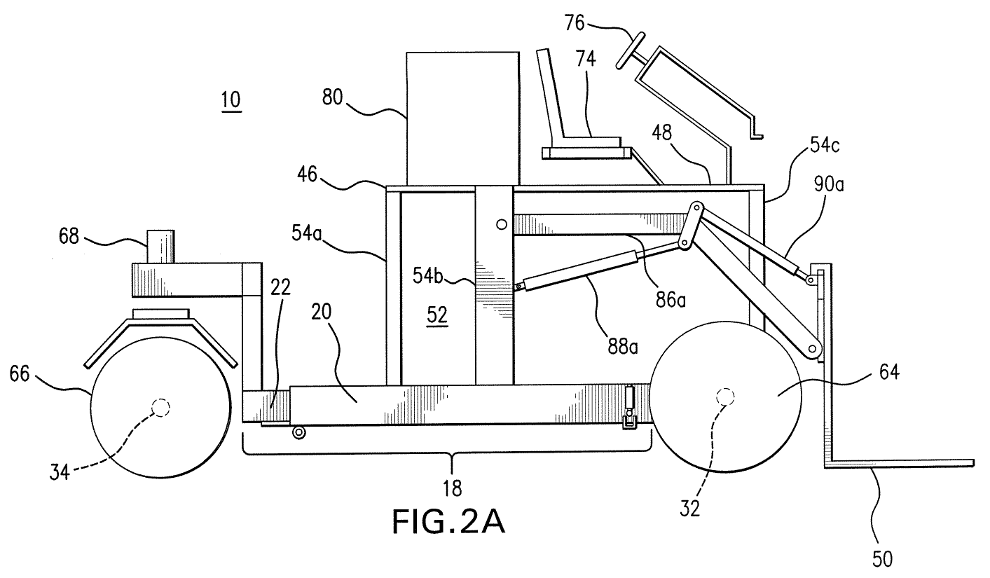

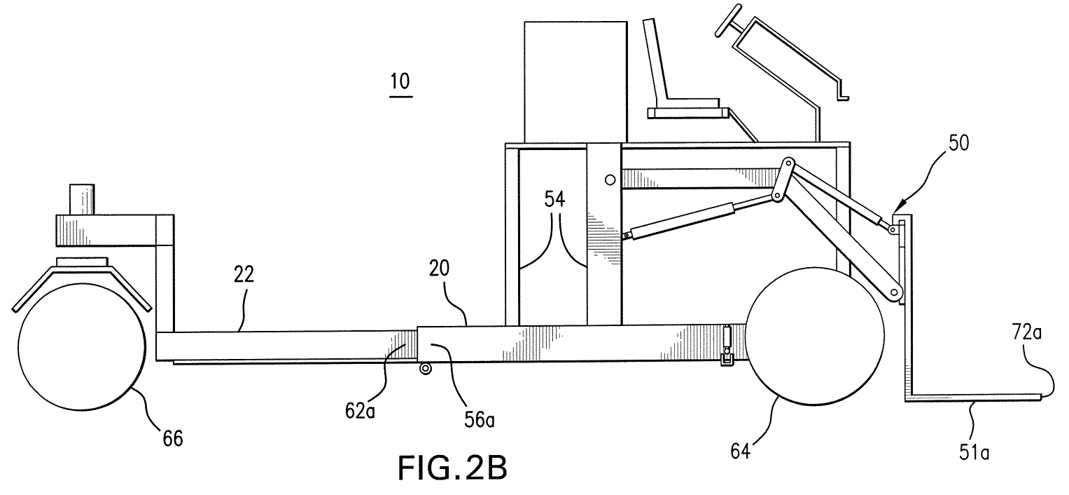

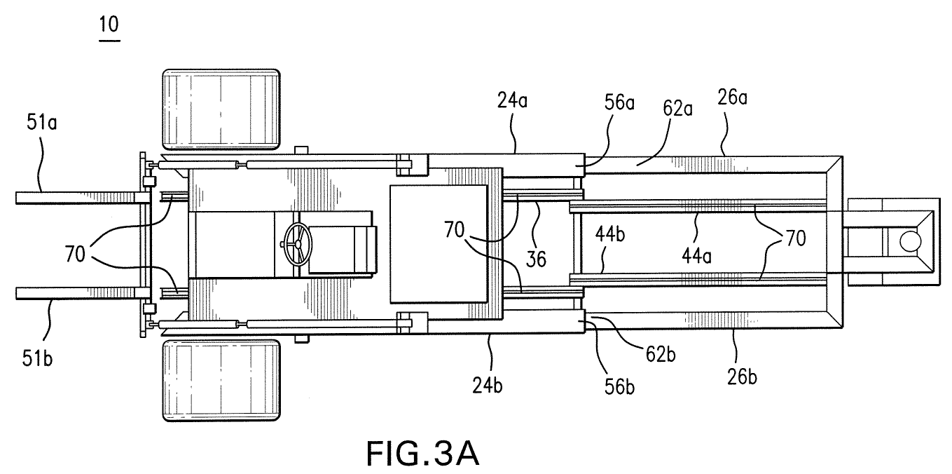

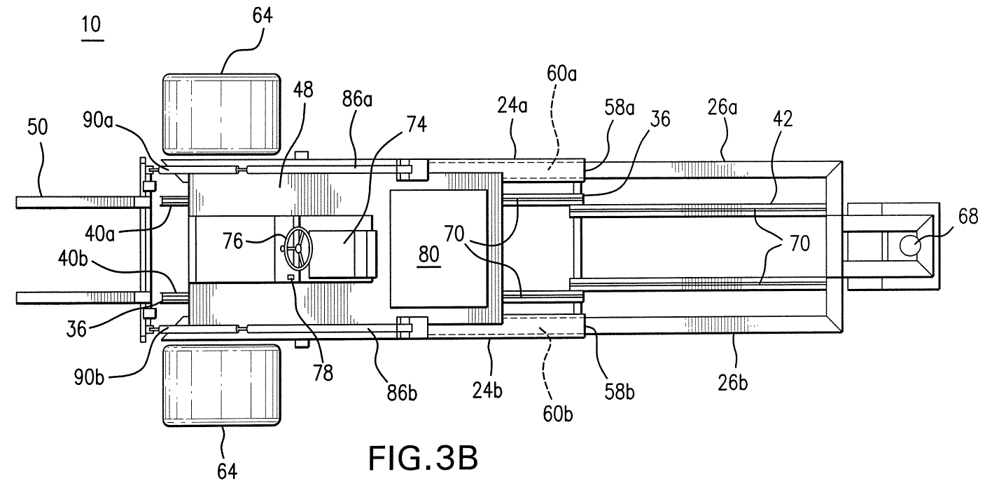

Referring now to FIGS. 1-6, an exemplary embodiment of a sod harvesting machine of the invention features a tractor 10 suitable for transporting palletized and stacked squares of sod 12 from the field 13 into the bed 16 of a flatbed truck 14. The tractor 10 includes an adjustable-length chassis 18 reconfigurable between an elongated configuration, shown in FIGS. 2B and 3A, which allows multiple (about 4 or 5) pallets of stacked sod to be stored on the tractor and a shortened configuration, shown in FIGS. 1 and 2A, which allows the tractor to be more maneuverable to facilitate loading of the pallets of stacked sod onto the bed 16 of the flatbed truck 14. The adjustable-length chassis 18 includes a front portion formed by a first frame 20 to which a front axle 32 can be connected and a rear portion formed by a second frame 22 to which a rear axle 34 can be connected. The tractor 10 further includes a front sod carriage 36 having a first lift member 38, a rear sod carriage 42, an elevated platform 46, and a second lift member 50. The tractor 10 also includes a sod storage compartment 52 defined by the first and second frames 20 and 22, the elevated platform 46, the front and rear sod carriages 36 and 42, and a support frame 54.

The first frame 20 may include a hollow longitudinal first front frame member 24a and a hollow longitudinal second front frame member 24b. In other embodiments, the first frame 20 may include more than two front frame members. The first and second front frame members 24a and 24b may be interconnected at one or more locations by one or more crossbars 28. The front frame members 24a and 24b may each have an open end 56a and 56b. The open ends 56a and 56b each include an aperture 58a and 58b leading into a longitudinal recess 60a and 60b formed within their respective front frame members 24a and 24b. For example, the first front frame member 24a may include a first open end 56a having a first aperture 58a that opens into a first longitudinal recess 60a, and the second front frame member 24b may include a second open end 56b having a second aperture 58b that opens into a second longitudinal recess 60b.

The second frame 22 of the tractor 10 can include a longitudinal first rear frame member 26a and a longitudinal second rear frame member 26b. In other embodiments, the second frame 22 may include more than two rear frame members. The first and second rear frame members 26a and 26b may be solid or hollow and are sized and shaped for insertion into the apertures 58a and 58b and longitudinal recesses 60a and 60b of the first and second front frame members 24a and 24b. The rear frame members 26a and 26b of the second frame 22 can be interconnected at one end by a crossbar 30. In other embodiments, the first and second rear frame members 26a and 26b may be interconnected at a plurality of locations by multiple crossbars. Each rear frame member 26a and 26b includes a free end 62a and 62b. The second frame 22 may be telescopically engaged by the first frame 20. For example, the free end 62a of the first rear frame member 26a can be slidably received into and engaged by the first longitudinal recess 60a of the first front frame member 24a. The second frame's first rear frame member 26a can be received into the first longitudinal recess 60a through the first aperture 58a of the first frame 20. Similarly, the free end 62b of the second frame's second rear frame member 26b can be received into the second longitudinal recess 60b through the second aperture 58b of the first frame 20. Thus, the front frame members 24a and 24b slidably engage the rear frame members 26a and 26b to permit the length of the chassis 18 to be adjusted as needed. The sod harvester 10 may include mechanical or hydraulic means for retracting and extending the rear frame members 26a and 26b into and out of the longitudinal recesses 60a and 60b through apertures 58a and 58b of the front frame members 24a and 24b.

A front wheel assembly 64 may be connected to the front axle 32 of the tractor 10 and a rear wheel assembly 66 may be connected to the rear axle 34. In an exemplary embodiment, the front wheel assembly 64 may include two wheels attached to the front axle 32 while the rear wheel assembly 66 can include a single wheel attached to the rear axle 34. The rear wheel assembly 66 can be mechanically connected to a steering motor 68 that may be mounted on the second frame 22. In an alternate embodiment, the front wheel assembly 64 may include more than two wheels, for example, four wheels. In another alternate embodiment, the rear wheel assembly 66 may include more than one wheel, for example, two wheels.

The front sod carriage 36 can be disposed between the first and second front frame members 24a and 24b and can include the first lift member 38. The first lift member 38 can include at least two prong members 40a and 40b. The first lift member 38 can be an interior forklift capable of performing low vertical lifting of pallets of stacked sod 12 off the ground and mechanically conveying the pallets one at a time via conveyor chains 70 to the rear of the sod storage compartment 52. The conveyor chains 70 are movably mounted on the prong members 40a and 40b of the first lift member (interior forklift) 38. Each prong member 40a and 40b of the interior forklift 38 may include one or more conveyor chains 50 installed longitudinally down the length of the prong. In an exemplary embodiment, the interior forklift 38 includes a low vertical lift. In another embodiment, the interior forklift 38 can be fixed in position with no vertical lifting ability.

The rear sod carriage 42 may also be disposed between the first and second front frame members 24a and 24b. The rear sod carriage 42 further includes at least two horizontal support members 44a and 44b that may include conveyor chains 70. In one embodiment, each horizontal support member 44a and 44b includes one or more conveyor chains 70 installed longitudinally down the length of the horizontal support member. The horizontal support members 44a and 44b of the rear sod carriage 42 can be slidably connected to the prong members 40a and 40b of the front sod carriage 36 so as to receive the pallets of stacked sod 12 as they are moved by the conveyor chains 70 of the front sod carriage toward the rear of the sod storage compartment 52. The horizontal support members 44a and 44b and prong members 40a and 40b may be arranged and connected in parallel. The slidable engagement of the front sod carriage 36 and the rear sod carriage 42 permit the length of the sod storage compartment 52 to be extended and retracted as needed.

The conveyor chains 70 of one or both of the front sod carriage 36 and the rear sod carriage 42 can be reversible in direction to permit the pallets of stacked sod 12 to be moved both into and out of the sod storage compartment 52.

The horizontal elevated platform 46 of the tractor 10 may be supported by the support frame 54. The support frame 54 may include several vertical support members 54a-f. A seat 74, steering controls 76, forklift controls 78, and an engine 80 can be mounted to a top surface 48 of the elevated platform 46.

The second lift member 50, which can be a front forklift 50, can be attached to the first frame 20 of the adjustable-length chassis 18 for lifting individual pallets of stacked sod 12 onto the bed 16 of the flatbed truck 14. The second lift member 50 may include a first prong 51a and a second prong 51b as shown in FIG. 3A. Tips 72a and 72b of the first and second prongs 51a and 51b are inserted beneath the pallet of stacked sod 12 so that the tractor 10 may lift the pallet of stacked sod. In alternate embodiments, the second lift member 50 may include more than two prongs or may be constructed as a platform lift. As shown in FIGS. 2A, 3B, and 6, the front forklift 50 can include right and left lift boom members 86a and 86b connected to vertical support members 54b and 54e. Left and right lift boom cylinders 88a and 88b and right and left tilt cylinders 90a and 90b are movably engaged with lift boom members 86a and 86b. The front forklift 50 can have a higher vertical lift than the interior forklift 38 and may be removed when not in use. The front forklift 50 can be raised or removed so that the interior forklift 38 and conveyor chains 70 can load the pallets of stacked sod 12 into the sod storage compartment 52.

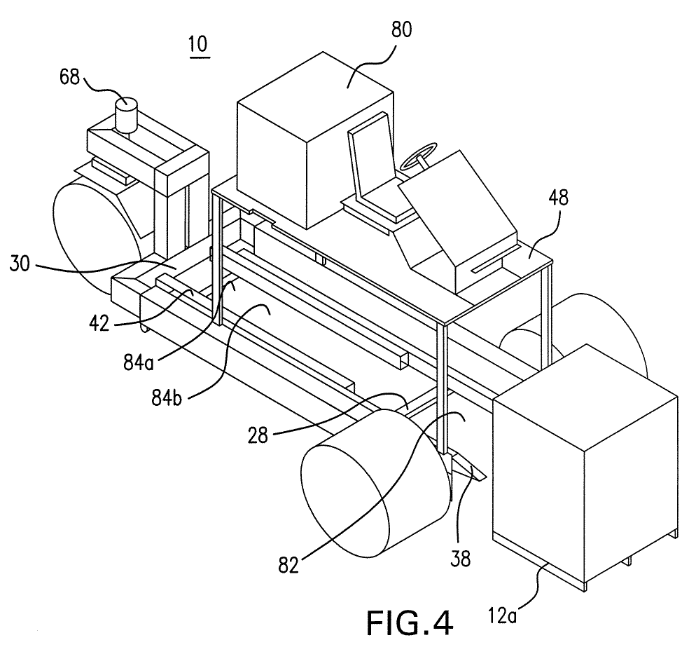

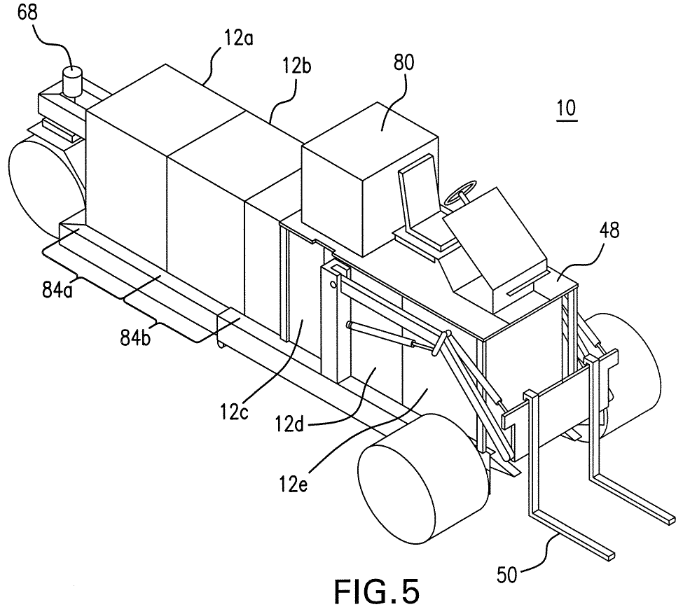

In operation, the tractor 10 can be driven into alignment with a pallet of stacked sod 12 as shown in FIG. 4, the conveyor chains 70 of the front and/or rear sod carriages 36 and 42 can be set into motion so that pallets of stacked sod are lifted by the prong members 40a and 40b and are then carried by the conveyor chains 70 into the sod storage compartment 52. For example, the tractor 10 can be used to lift a first pallet of stacked sod 12a into a starting position 82. The starting position 82 may be located between the prong members 51a and 51b of the interior forklift (first lift member) 38. The first pallet of stacked sod 12a can be mechanically conveyed by the conveyor chains 70 from the starting position 82 to a first (rear) position 84a within the sod storage compartment 52 of the tractor 10. The tractor 10 can then be used to lift a second pallet of stacked sod 12b into the starting position 82. The second pallet of stacked sod 12b may be mechanically conveyed by the conveyor chains 70 from the starting position 82 to a second (rear) position 84b within the sod storage compartment 52. These steps are repeated until about five (e.g., about 1, 2, 3, 4, 5, 6, 7, or 8) stacked pallets of sod 12a-e are disposed within the sod storage compartment as shown in FIG. 5. The adjustable-length chassis 18 of the tractor 10 may be extended to increase the capacity of the tractor's sod storage compartment 52 for storing and transporting pallets of stacked sod 12.

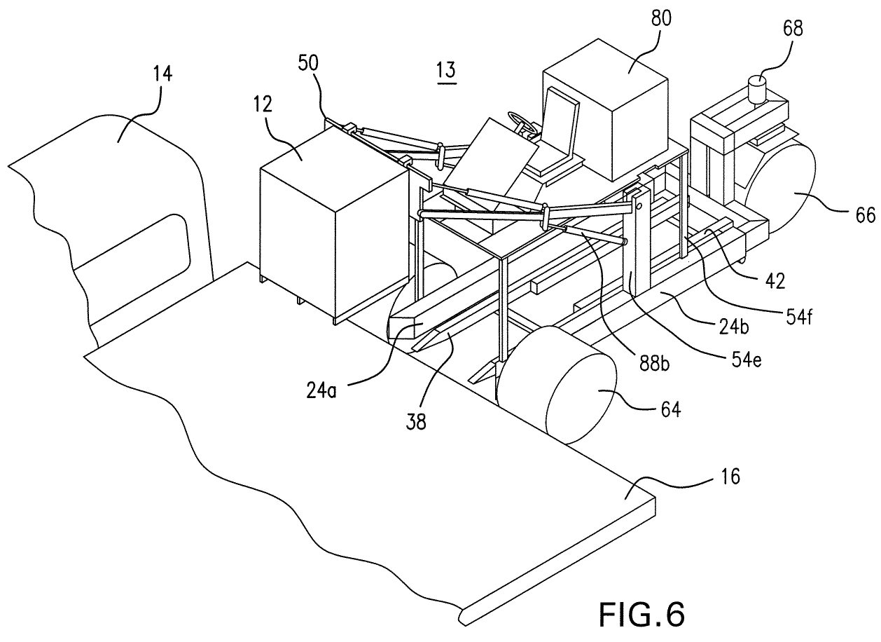

Once loaded with 4-5 pallets of stacked sod, the tractor 10 can be driven from the field to an unloading location which can be an area or field 13 adjacent to a flatbed truck 14. With the front forklift (second lift member) 50 raised or removed, each of the pallets of stacked sod 12 are mechanically disgorged from the tractor's sod storage compartment 52 by reversing the direction of movement of the conveyor chains 70. The interior forklift 38 may be used to lower each pallet of stacked sod 12 onto the ground. Referring now to FIG. 6, the adjustable-length chassis 18 of the tractor 10 may then be placed into the shortened configuration and the pallets of stacked sod 12 are placed onto a bed 16 of the flatbed truck 14 using the tractor's front forklift 50 in the same manner as a conventional forklift.

### Other Embodiments

It is to be understood that while the invention has been described in conjunction with the detailed description thereof, the foregoing description is intended to illustrate and not limit the scope of the invention, which is defined by the scope of the appended claims. For example, the machine described herein can be used or adapted for use in transported palletized goods aside from sod. Other aspects, advantages, and modifications are within the scope of the following claims.

What is claimed is:

1. A sod harvesting machine comprising:
a tractor comprising:
a first frame comprising a first longitudinal member and a second longitudinal member;
a front sod carriage comprising:
a first lift member for lifting at least a first pallet of stacked sod;
wherein the front sod carriage is disposed between the first and second longitudinal members of the first frame;
a rear sod carriage disposed between the first and second longitudinal members of the first frame and connected to the front sod carriage so as to receive at least the first pallet of stacked sod;
an elevated platform which is supported by a plurality of vertical support members connected to the first frame of the tractor;
wherein the first frame, the plurality of vertical support members, the elevated platform, the front sod carriage, the rear sod carriage form a sod storage compartment within which at least the first pallet of sod is transported; and
a second lift member for lifting and transferring at least the first pallet of stacked sod.

2. The sod harvesting machine of claim 1, wherein the tractor further comprises a second frame.

3. The sod harvesting machine of claim 2, wherein the first longitudinal member of the first frame comprises a first open end comprising a first aperture that opens into a first longitudinal recess formed inside of the first longitudinal member;
wherein the second longitudinal member of the first frame comprises a second open end comprising a second aperture that opens into a second longitudinal recess formed inside of the second longitudinal member;
wherein the first aperture of the first longitudinal member receives a first longitudinal member of the second frame which is slidably engaged within the first longitudinal recess; and
wherein the second aperture of the second longitudinal member receives a second longitudinal member of the second frame which is slidably engaged within the second longitudinal recess.

4. The sod harvesting machine of claim 3, wherein the second frame is telescopically engaged by the first frame.

5. The sod harvesting machine of claim 4, wherein the rear wheel assembly is attached to the second frame.

6. The sod harvesting machine of claim 5, wherein the rear wheel assembly comprises a single wheel mechanically connected to a steering motor.

7. The sod harvesting machine of claim 1, wherein at least one of the group consisting of: a seat, steering controls, lift member controls, and an engine, is mounted to a top surface of the elevated platform.

8. The sod harvesting machine of claim 1, wherein the front sod carriage further comprises at least two prong members.

9. The sod harvesting machine of claim 8, wherein the at least two prong members comprise conveyor chains.

10. The sod harvesting machine of claim 1, wherein the rear sod carriage further comprises at least two horizontal support members.

11. The sod harvesting machine of claim 10, wherein the at least two horizontal support members comprise conveyor chains.

12. The sod harvesting machine of claim 1, wherein the front sod carriage comprises at least two prong members and the rear sod carriage comprises at least two horizontal support members; and
wherein the at least two prong members and the at least two horizontal support members are slidably engaged and are arranged in parallel.

13. The sod harvesting machine of claim 4, wherein the tractor further comprises hydraulic means for extending the first and second longitudinal members of the second frame out of the first and second apertures and first and second longitudinal recesses of the first frame.

14. The sod harvesting machine of claim 4, wherein the second frame is telescopically extendable out of the first frame to increase the length of the tractor's sod storage compartment so as to accommodate about five pallets of stacked sod.

15. The sod harvesting machine of claim 4, wherein the tractor further comprises mechanical means for extending the first and second longitudinal members of the second frame out of the first and second apertures and first and second longitudinal recesses of the first frame.

16. A sod harvesting machine comprising:
a tractor comprising:
an adjustable-length chassis;
an interior forklift comprising one or more conveyor chains for lifting pallets of stacked sod;
an elevated platform, further comprising a support frame, for supporting a seat, steering, forklift controls, and an engine;
a central storage area defined by the elevated platform, the support frame, and the interior forklift and into which the conveyor chains transport the pallets of stacked sod; and
a front forklift attached to the chassis for lifting individual pallets of stacked sod onto a flatbed truck.

17. A method comprising the steps of:
(a) using a machine to lift a first pallet of stacked sod into a starting position;
(b) mechanically conveying the first pallet of stacked sod from the starting position to a first position within a storage compartment inside the machine;
(c) using the machine to lift a second pallet of stacked sod into the starting position;
(d) mechanically conveying the second pallet of stacked sod from the starting position to a second position within the storage compartment; and
(e) transporting the first and second pallets of stacked sod to an unloading location.

18. The method of claim 17, further comprising the steps of:
(f) mechanically conveying the second pallet of stacked sod to the starting position;
(g) using the machine to lower the second pallet of stacked sod onto the ground;
(h) mechanically conveying the first pallet of stacked sod to the starting position; and
(i) using the machine to lower the first pallet of stacked sod onto the ground.

19. The method of claim 18, further comprising the steps of:
(j) using the machine to lift the first and second pallets of stacked sod from the ground onto a truck bed for transportation.

20. The method of claim 17, further comprising the step of:
(k) extending the frame of the machine to increase the capacity of the machine's storage compartment for storing and transporting pallets of stacked sod.
